(19) United States
(12) Patent Application Publication
(10) Pub. No.: US 2001/0052847 A1
(43) Pub. Date: Dec. 20, 2001

(54) AUTOMATIC TELEPHONE NOTIFICATION OF LOCATIONS IN A TORNADO PATH

(76) Inventor: MITCHELL J. AUERBACH, MELBOURNE, FL (US)

Correspondence Address: MITCHELL AUERBACH, 2496 PARK PLACE BOULEVARD, MELBOURNE, FL, 32935, US

(21) Appl. No.: 09/454,507

(22) Filed: Dec. 6, 1999

(51) Int. Cl. G08B 21/00

(52) U.S. Cl. 340/540; 340/601

(57) ABSTRACT

An active early warning system for storms that uses weather radar data as input to a computer which in turn projects the likely path of a tornado. The computer then accesses a database which contains telephone numbers and the telephone's geographic location. The phone numbers which are in the projected path of the tornado are dialed automatically and the called parties are notified via computer message. This provides individuals who are the most likely potential victims of a tornado with the earliest possible notification. By using geographic data which is related to the telephone number, the computer will not waste any time calling numbers which are not in the path of the tornado. This avoids unnecessarily alarming individuals who are not at risk and ensures that those who are at risk are notified.

### CROSS-REFERENCE TO RELATED APPLICATIONS

This application is a non-provisional continuation application of the commonly owned copending application entitled “Emergency Management Communications System”, filed Dec. 7, 1998, bearing U.S. Ser. No. 60/111,281 and naming Mitchell Auerbach, the named inventor herein, as inventor, and John Root, as an inventor, the contents of which is specifically incorporated by reference herein in its entirety; and the commonly owned copending application entitled “Automatic Telephone Notification of Locations in a Tornado Path”, filed Feb. 16, 1999, bearing U.S. Ser. No. 60/120,096 and naming Mitchell Auerbach, the named inventor herein, as sole inventor, the contents of which is specifically incorporated by reference herein in its entirety.

### BACKGROUND OF THE INVENTION

1. Technical Field

The present invention relates to storm warning systems. In particular, it relates to storm warning systems capable of identifying locations in the path of an impending storm and automatically notifying individuals at those specific locations the direct telephone communication.

2. Background Art

Tornado damage poses a high risk to individuals in many areas of the country. With the advent of sophisticated weather radar systems it has now become possible to analyze storm systems by inputting weather data from a weather radar system to a computer. The computer, in turn, can use the weather radar data as source data for computer software that predicts the likelihood of a tornado and its most likely path over a geographic area.

While these systems are capable of producing an indication of the most likely path of the tornado, the data they produce does not help protect the individuals and property in the path of the tornado if those individuals cannot be effectively alerted to the impending danger. Conventional warning systems use mass media technology such as television and radio to alert the public at-large.

A disadvantage to this method is that this type of warning system is passive and requires that the individuals which the system seeks to alert are actively and attentively watching or listening to one of the broadcast media channels. Unfortunately, not everyone in the path of a tornado will be attentively watching the television or listening to the radio in the brief time period when they need to be alerted. Further, even if individuals in the path of a tornado are watching television or listening to radio, they may still misinterpret the message being broadcast and not take appropriate action.

It would be advantageous to have an active warning system, rather than the passive warning system of the prior art, that is capable of actively and directly notifying those in the path of the tornado such that they have adequate time to take action to protect themselves or their property.

The prior art has failed to provide an active warning system that will allow direct notification of potential victims while providing them with adequate time to take action, and has instead relied on passive mass media communications channels which may not reach those in the path of a tornado.

While addressing the basic desirability of using detection equipment, such as radar, to predict the path of potential tornadoes, the prior art has failed to provide an active warning system which can utilize the radar data to identify the most likely individuals in the path of an impending storm and automatically warn those individuals via direct communication.

### SUMMARY OF THE INVENTION

The present invention solves this problem by providing an active warning system that uses weather radar data as input to a computer which in turn projects the likely path of a tornado. The system users the projected path of a tornado to define a specific geographic area which is at risk of a tornado strike. The system also includes a database which contains telephone numbers and the geographic location of each telephone number. Once the geographic area of a potential tornado strike is determined, the database is examined to select all of the phone numbers in that geographic area. The selected telephone numbers are then automatically dialed. When the individual answers to telephone, a computer-generated message is presented to the individual which describes in detail the potential danger of a tornado strike. This provides the potential victims with the earliest possible notification, and more important, it is an active and direct communication which by its nature forces the individual to pay attention to the warning. By using geographic data that is related to the telephone number, the computer will not waste any time calling numbers which are not in the path of the tornado. This also avoids unnecessarily alarming individuals who are not at risk and ensures that those who are at risk are notified in the fastest possible manner.

### BRIEF DESCRIPTION OF THE DRAWINGS

FIG. 1 is a diagram illustrating storm locations, projected tornado paths, locations of houses, and the location of the weather radar station.

FIG. 2 is a flow chart of a preferred embodiment of the invention which illustrates how weather radar data is used to identify and initiate calls to telephone numbers in the path of an impending tornado when the impending tornado is first discovered.

FIG. 3 is a flow chart of a preferred embodiment of the invention which illustrates how weather radar data is used to update the list of telephone numbers in the path of an impending tornado when the course of the impending tornado has changed.

### DESCRIPTION OF THE PREFERRED EMBODIMENT

Prior to a detailed discussion of the figures, a general overview of the features and advantages of the invention will be presented. The invention uses weather radar data to determine the most likely path of a tornado and uses that data to select geographic locations that are most likely to be in the path of the tornado. A database containing telephone numbers and their associated geographic locations is also maintained by the system. Once the geographic area of a potential tornado strike is determined, a computer program accesses the database to determine the telephone numbers which are located within that geographic area. Those telephone numbers are then automatically called by the computer. When the telephone call is answered, the computer automatically plays a message to the individual which provides specific data related to the impending tornado strike. This allows individuals who have the highest probability of being endangered by the tornado to be given the maximum amount of warning time.

Those skilled in the art will recognize that passive prior art communication means such as radio and television alerts can also be used. However, because these systems are passive, they have to rely on the chance occurrence that an individual in the path of a tornado may happen to the listening, and paying attention to, the alert being transmitted by the television or radio station. On the other hand, the telephone based system taught herein is an active system that creates a direct connection with an individual user. The act of answering the telephone focuses the individual's attention on the warning message which improves the chances that the individual will act on the information received. The prior art passive alert systems may be ignored by individual or may not even be received by them.

By placing the telephone calls to only those geographic areas that are likely to be effected, the system is able to reduce the number of calls to a level which allows the earliest notification and also allows the system to be effectively used. Without knowledge of the geographic locations which are in the path of the tornado, the number of locations which would have to be called may overload the capacity of the system. In addition, telephone calls made to individuals outside of the potential tornado path would unnecessarily alarm those individuals for no reason.

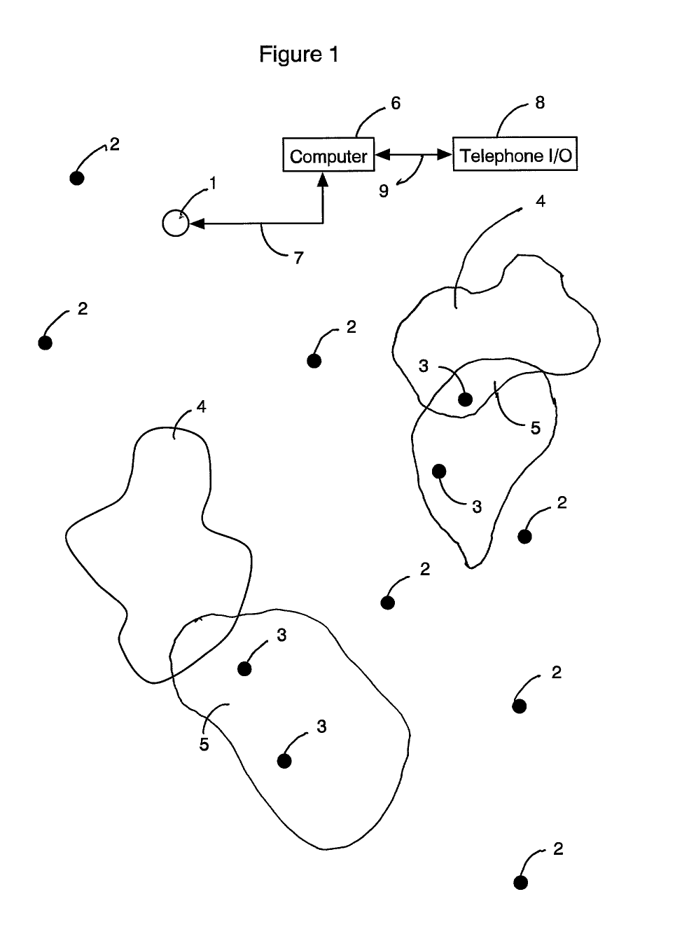

Referring to FIG. 1, this figure shows a radar system 1 which collects data from storm systems 4. Based on the data derived from the storm systems 4, the computer 6, using known techniques, projects the geographic area which has a significant possibility of being in a potential tornado path 5. In a particular geographic area, there may be many locations 2 outside of the potential tornado path 5, and many locations 3 inside of the potential tornado path 5.

The computer 6 has a database which contains telephone numbers and geographic location data related to each telephone number. The computer 6, having determined the geographic area covered by the potential tornado path 5, accesses the database containing geographic information related to telephone numbers and then uses telephone I/O 8 (input/output call placement devices such as PBXs, etc.) to call all of the locations 3 within the tornado path 5. The weather radar 1 communicates with the computer 6 via communications link 7. For ease of illustration, the computer 6 is shown at a separate location from weather radar system 1. Those skilled in the art will realize that it does not matter whether the computer 6 and the weather radar system 1 are separate or located in the same facility. In addition, the communications link 7 can be a direct hard wired connection, or can be any other suitable method of connection, such as land telephone line, cellular telephone, radio communications, satellite interface, wireless interface, the computer network interface such as the Internet, etc.. Likewise, the computer 6 is shown attached to telephone I/O 9 via a communications link 8. As was the case above in regard to communications link 7, the computer 6 and the telephone I/O 9 can be connected via any suitable method. Likewise, they can be located in the same facility or they can be remotely located from one another. The only requirement for communications links 7 and 8 is that they provide an efficient link with suitable performance characteristics.

The system allows individuals to be automatically notified by the computer 6 via conventional telephone calls when they are in the potential tornado path 5. The individuals will receive telephone calls that directly and clearly notify them that they are in danger and that they should take action. As can be seen, by only notifying the selected subset of telephone numbers which are in actual danger, this system more effectively and more quickly notifies those at greatest risk.

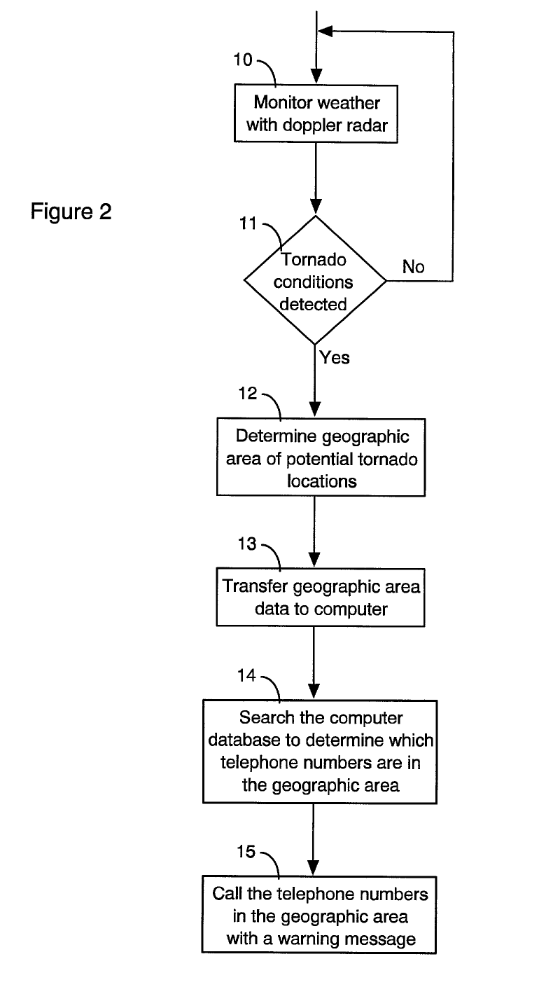

Regarding FIG. 2, this figure is a flow chart which illustrates the initial sequence of events that occur from the time the potential tornado is detected until those individuals in the path of the potential tornado have been notified.

The weather is monitored at step 10 on a continuous basis for the purpose of detecting storm conditions, and a particular, potential tornadoes. This would typically be done by a Doppler weather radar system 1. Doppler weather radar systems 1 and the generation of data indicating potential tornado paths are well-known in the art. The Doppler radar system 1 would continuously monitor for potential tornadoes at step 11. Once a potential tornado is detected, the geographic area 5 in which the potential tornado may occur is calculated at step 12. Determination of the geographic area 5 is well-known in the art. Typically, the geographic area 5 would be illustrated as a trapezoid shape that is defined by four corner points. However, more sophisticated prediction tools may use more than four points. In fact, if enough points are used, the shape of the geographic area may form an irregular shape with an unlimited number of border points. For ease of illustration, the potential tornado path has been illustrated in FIG. 1 as an irregular shaped geographic area 5, but it is also intended to include the most basic form which is a trapezoid.

The computer 6 would then input the geographic area data 5 at step 13. This data can be transferred from the Doppler radar system 1 to the computer 6 by any convenient means. For example, any type of telephone communications can be used, including land lines, cellular telephone communications, or any other wireless communications means. Likewise, an Internet connection can be used to transfer data from the weather radar system 1 to the computer 6. Satellite communications can also be used for this purpose. The only requirement is that the data must be quickly and accurately transferred to the computer 6. Once that objective has been met, other factors such as which method of data transfer is most economical can be considered.

At step 14, the computer 6 would take the geographic area data 5 and use that data to search a database having both telephone number information and geographic information related to each telephone number. When the computer 6 determined that the geographic information related to a particular telephone number indicated that the telephone was located within the geographic area defined by the geographic area data 5, the telephone number was selected because it was within the path of a potential tornado.

At step 15, each selected telephone number is called automatically by the telephone I/O 9 under control of the computer 6. Those skilled in the art will recognize that in heavily populated areas, the active warning system hardware and requires the use of an adequate number of telephone lines to allow multiple individuals to be simultaneously contacted by the computer 6. Likewise, the performance of the system can be impacted by the equipment available at the telephone company's central office switching center.

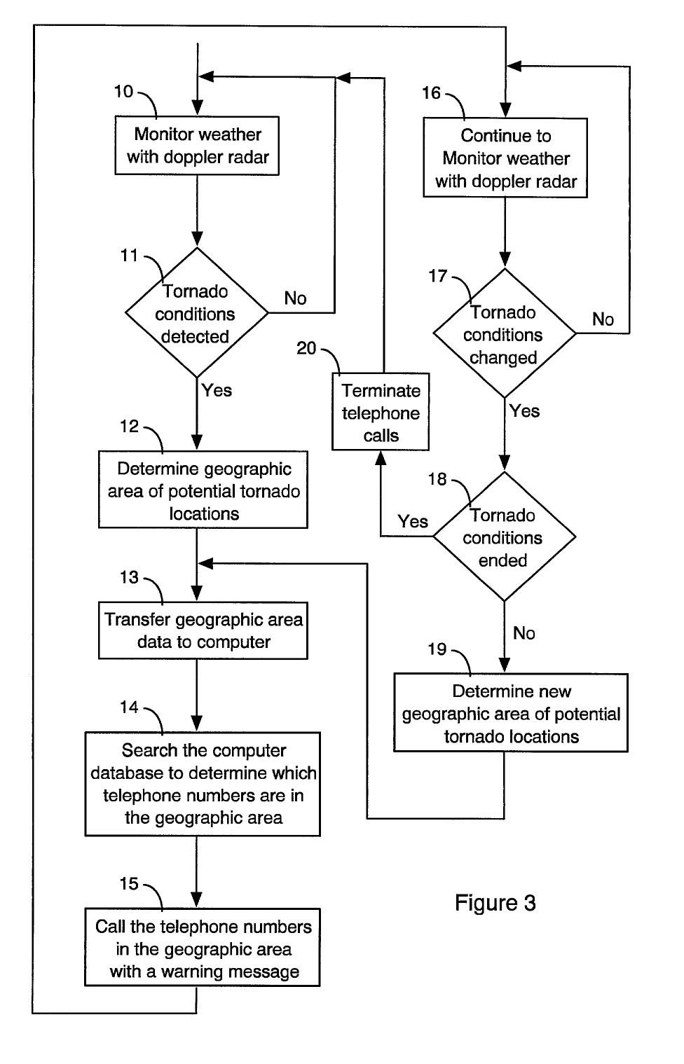

FIG. 3 illustrates how the system adapts to changes in the path of a tornado. Once the system begins calling individuals in a potential tornado path 5 and step 15, it continues to monitor weather at step 16. At step 17, if no change is found in the tornado path 5, the system will continue to monitor the weather. However, if a change is found in the tornado path 5, the system will then determine if the tornado threat has ended at step 18. It Attorney of threat has ended, then the system will terminate the telephone calls at step 20 and return to step 10 to continue to monitor the weather. On the other hand, if at step 18 a change in the tornado path 5 is detected, then the system will determine, at step 19, a new geographic area for the terminate a path 5. This updated tornado path 5 data will then be input into step 13 which will begin the process of updating the telephone call list. This update may result and some of the telephone numbers on the call list being removed and some new telephone numbers being added to the call list.

Those skilled in the art will recognize that a variety of techniques can be used to define geographic area data. For example, geographic area data can be defined as longitudinal/latitudinal coordinates or GPS format data, it can be defined in terms of Postal Service Zip codes, defined in terms of telephone prefix numbers such as area code or exchange code numbers, it can be defined in terms of town or locality names, etc.. In addition, it is conceivable for a single Doppler radar system 1 to output data in one format to one more systems in one data format, while the receiving computer may have telephone location data in a different format. In that case, the computer software would convert either the received data or the telephone location data to allow a comparison data of purpose of selecting appropriate telephone numbers. In addition, the method used to define to the geographic area data will affect the precision of the area selected.

In addition to using the foregoing information to select telephone numbers to be called, the system is also capable of using specialized information such as CIC numbers which define business or organization functions to prioritize the telephone calls. For example, in the event that a potential tornado is indicated by the Doppler radar 1, the CIC codes can be used to identify telephone numbers of locations which may require more time to prepare for a tornado, such as nursing homes, hospitals, day-care centers, etc.. These organizations may even have their calls processed by separate telephone I/O device to insure that there is no delay in placing the call.

While the invention has been described with respect to a preferred embodiment thereof, it will be understood by those skilled in the art that various changes in detail may be made therein without departing from the spirit, scope, and teaching of the invention. For example, the information used to construct the table may be telephone number data, zip code data, or any other data that would indicate geographic location, the size of the area notified may vary based on the expected accuracy system. Likewise, other types of information such as CIC data can be used to identify special locations which may have greater time constraints. The special locations may include hospitals, nursing homes, etc.. The type of radar system, the type of computer, the type of communications links, and the type of telephone equipment in vary, etc.. Accordingly, the invention herein disclosed is to be limited only as specified in the following claims.

I claim:

1. An active tornado warning system, further comprising:
a weather radar system, further comprising:
means to generate geographic coordinates of areas at risk of tornado activity; and
means to output the geographic coordinates;
a computer, further comprising:
input means to receive the geographic coordinates;
a database having telephone numbers for selected geographic areas and geographic location data for the telephone numbers;
means to select telephone numbers within the geographic coordinates by comparing the geographic coordinates with the geographic location data for the telephone numbers; and
means to output a predetermined message and the selected telephone numbers; and
telephone I/O having means to input the predetermined message and the selected telephone numbers output by the computer and means to automatically dial the selected telephone numbers and play the predetermined message when the telephone call is answered;
whereby individuals in the path of a potential tornado are automatically warned by comparing the projected geographic area of potential tornado activity with geographic location data associated with individual telephone numbers and automatically placing a telephone call to provide a warning message to the telephone numbers which are in the geographic area of potential tomato activity when the telephone call is answered.

2. A system, as in claim 1, wherein:
the database uses longitudinal/latitudinal coordinates as the geographic location data; and
the computer has means to compare the geographic coordinates with the longitudinal/latitudinal coordinates.

3. A system, as in claim 2, wherein:
the database further includes CIC code information related to each telephone number; and
means to prioritize calls based on the CIC code information;
whereby selected telephone numbers may be given call priority based on the CIC code information.

4. A system, as in claim 1, wherein:
the database uses zip code information as the geographic location data; and
the computer has means to compare the geographic coordinates with the zip code information.

5. A system, as in claim 4, wherein:
the database further includes CIC code information related to each telephone number; and
means to prioritize calls based on the CIC code information;
whereby selected telephone numbers may be given call priority based on the CIC code information.

6. A system, as in claim 1, wherein:
the database uses telephone prefix information as the geographic location data; and
the computer has means to compare the geographic coordinates with the telephone prefix information.

7. A system, as in claim 1, wherein:
the radar weather system and the computer communicate with one another via a telephone interface.

8. A system, as in claim 1, wherein:
the radar weather system and the computer communicate with one another via a wireless interface.

9. A system, as in claim 1, wherein:
the radar weather system and the computer communicate with one another via a computer network.

10. A system, as in claim 1, wherein:
the radar weather system and the computer communicate with one another via satellite communications.

11. A method of directly communicating with telephones in the path of a potential tornado, including the steps of:
using a weather radar system to generate geographic coordinates of areas at risk of tornado activity, and outputting the geographic coordinates to a computer;
using a computer to input the geographic coordinates from the weather radar system;
using a database having telephone numbers for selected geographic areas and geographic location data for the telephone numbers;
selecting telephone numbers within the geographic coordinates by comparing the geographic coordinates with the geographic location data for the telephone numbers; and
outputting a predetermined message and the selected telephone numbers; and
using telephone I/O to automatically dial the selected telephone numbers and to automatically play the predetermined message when the dial telephone number is answered;
whereby individuals in the path of a potential tornado are automatically called with a warning message.

12. A method, as in claim 11, including the additional steps of:
using longitudinal/latitudinal coordinates as the geographic location data in the database; and
providing means to the computer to compare the geographic coordinates with the longitudinal/latitudinal coordinates.

13. A method, as in claim 12, including the additional steps of:
including CIC code information related to each telephone number in the database; and
prioritizing calls based on the CIC code information;
whereby selected telephone numbers may be given call priority based on the CIC code information.

14. A method, as in claim 11, including the additional steps of:
using zip code information as the geographic location data in the database; and
using the computer to compare the geographic coordinates with the zip code information.

15. A method, as in claim 14, including the additional steps of:
including CIC code information related to each telephone number in the database; and
prioritizing calls based on the CIC code information;
whereby selected telephone numbers may be given call priority based on the CIC code information.

16. A method, as in claim 11, including the additional steps of:
using telephone prefix information as the geographic location data in the database; and
using the computer to compare the geographic coordinates with the telephone prefix information.

17. A method, as in claim 11, including the additional step of using the telephone interface to communicate between the radar weather system and the computer.

18. A method, as in claim 11, including the additional step of using a wireless interface to communicate between the radar weather system and the computer.

19. A method, as in claim 11, including the additional step of using a computer network communicate between the radar weather system and the computer.

20. A method, as in claim 11, including the additional step of using a satellite communications system to communicate between the radar weather system and the computer.
